(19) United States
(12) Patent Application Publication
(10) Pub. No.: US 2024/0337024 A1
(43) Pub. Date: Oct. 10, 2024

(54) METHOD OF ADDITIVE MANUFACTURING OF REFRACTORY ALLOY COATINGS

(71) Applicant: Purdue Research Foundation, West Lafayette, IN (US)

(72) Inventors: Yung C. Shin, West Lafayette, IN (US); Kyung-Min Hong, San Jose, CA (US)

(21) Appl. No.: 18/626,663

(22) Filed: Apr. 4, 2024

Related U.S. Application Data
(60) Provisional application No. 63/494,358, filed on Apr. 5, 2023.

(51) Int. Cl. C23C 24/10; B22F 10/28; B22F 10/64; B33Y 10/00; B33Y 40/20; B33Y 80/00; C22C 19/05; C22C 19/07

(52) U.S. Cl. CPC C23C 24/106; B22F 10/28; B22F 10/64; B33Y 10/00; B33Y 40/20; B33Y 80/00; C22C 19/055; C22C 19/07; B22F 2301/15; B22F 2998/10; B22F 2999/00

(57) ABSTRACT

Methods of additive manufacturing of refractory alloy coating. Such methods include forming a refractory alloy coating on a substrate using a laser powder bed fusion (L-PBF) process with a refractory alloy and removing cracks from the refractory alloy coating by remelting the refractory alloy coating with a laser.

### CROSS-REFERENCE TO RELATED APPLICATIONS

This application claims the benefit of provisional U.S. Patent Application No. 63/494,358 filed Apr. 5, 2023, the contents of which are incorporated herein by reference.

### STATEMENT REGARDING FEDERALLY SPONSORED RESEARCH

This invention was made with government support under Grant Number DE-FE0031820 awarded by the Department of Energy. The government has certain rights in the invention.

### BACKGROUND OF THE INVENTION

The invention generally relates to methods of additive manufacturing of refractory alloy coatings.

Many Co, Cr, and Ni-based alloys are known as coating materials to improve surface properties such as wear, corrosion, and erosion resistance. Among them, cobalt and nickel-based families of alloys commercially available under the Tribaloy® from Kennametal Inc. are known for their outstanding resistance to degradation caused by corrosion/oxidation, wear, and erosion over a wide range of temperatures. These Tribaloy® alloys are typically used in applications where extreme wear under high temperatures and corrosive media may occur, such as in industrial turbine applications, commercial jet engines, and rocket engines. As a nonlimiting example, high-pressure (HP) turbine blades are susceptible to solid particle erosion (SPE) effect, which causes material removal from the component surface due to the impingement of solid particles carried in a high-speed gas or liquid jet.

The strong wear resistance properties and hardness of Tribaloy® alloys are generally provided by the large fractions of the intermetallic Laves phases dispersed in a eutectic matrix of Laves phases and a Co or Ni-based solid solution. The volume fraction of the Laves phases varies from 40 to 64 percent in the Tribaloy® family of T-400 and T-800 CoMoCrSi alloys. The Laves phases have a C14-type (MgZn₂) phase with a melting point of about 1560° C. with Co₃Mo₂Si and CoMoSi in Co-based alloys. These Laves phases have a reported hardness value approaching 1000-1200 HV. Various studies have discussed the excellent abrasive and sliding wear behavior of Co-based alloys. For example, one study conducted sliding wear tests and revealed that a T-800 coating on stainless steel (AISI 304) led to a wear coefficient (K) decrease of one to two orders of magnitude compared with the uncoated substrate. Another study reported that the wear resistance of the T-400C alloy could be further improved via solution treatment. At elevated temperatures (750° C.), an increase in wear resistance is expected for CoMoCrSi coatings due to the formation of a continuous, adherent protective Cr₂O₃ oxide film.

The presence of the Laves phase yields excellent resistance to abrasive wear, but the lack of ductility of CoMoCrSi makes it challenging to apply crack-free coatings on components. Tribaloy® CoMoCrSi coatings have been deposited by high-velocity oxygen fuel (HVOF). However, due to a shallow heating zone of the HVOF process, the deposited coating does not have a robust metallurgical bonding with the substrate. In addition, the thermal deposition techniques, such as atmospheric plasma spray (APS), high-velocity oxygen fuel (HVOF), usually show relatively high oxide contents and porosity levels. The relatively high oxide contents of thermal sprayed coatings cause a decrease in the oxidation resistance.

Laser deposition processes have been introduced to apply Tribaloy® CoMoCrSi coatings with lower oxide contents. Laser cladding (also referred to herein as laser additive manufacturing) usually results in a dense coating (cladding) layer with a fine microstructure and good adherence by means of metallurgical bonding to the substrates on which they are deposited. Despite having good metallurgical bonding, coatings deposited by laser deposition processes are subjected to a mismatch of thermal expansion coefficients and a temperature gradient, inducing high thermal stresses that exacerbate the propensity for crack formation in the coatings. In conventional techniques, laser cladding processes have included preheating the substrate to build a crack-free coating. However, the preheating process can cause dilution between the primary substrate and coating material during the laser deposition process. The dilution of the coating caused by the preheating of the substrate can severely alter the microstructure and resulting material properties The forming of a bi-material by a laser powder bed fusion (L-PBF) process has been demonstrated, in which a NiCrAlY coating was deposited on a nickel-based Alloy 625 substrate for use in high-temperature applications. The coating showed excellent adhesion, and the phase concentration progressively changed at the interface.

It would be desirable if methods were available for forming refractory alloy coatings on substrates having different compositions than the coatings, in which the methods are capable of reducing or eliminating cracking of the coatings and/or capable of preserving the properties of the refractory alloy by reducing or eliminating diffusion between the coatings and substrates.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods suitable for additive manufacturing of refractory alloy coatings.

According to one nonlimiting aspect of the invention, a method of additive manufacturing of refractory alloy coating includes forming a refractory alloy coating on a substrate using a laser powder bed fusion (L-PBF) process with a refractory alloy, and removing cracks from the refractory alloy coating by remelting the refractory alloy coating with a laser.

Technical aspects of methods as described above preferably include the ability to deposit refractory alloy coatings by an additive manufacturing technique without cracks.

These and other aspects, arrangements, features, and/or technical effects will become apparent upon detailed inspection of the figures and the following description.

### BRIEF DESCRIPTION OF THE DRAWINGS

FIGS. 1A-1D relate to processing of a CoMoCrSi alloy (Praxair CO-109) deposited by a multi-track laser powder bed fusion (L-PBF) process. FIG. 1A shows an example of balling of a powder of the CoMoCrSi alloy, FIG. 1B shows an example of crack formation in a deposited coating of the CoMoCrSi alloy, and FIG. 1C shows an example of undulation in a coating of the CoMoCrSi alloy from a large hatch distance. FIG. 1D shows a processing window determined to prevent balling, cracks, and undulation in the CoMoCrSi alloy.

FIGS. 2A and 2B are optical microscope images of cross-sectioned CoMoCrSi coatings formed in accordance with certain aspects of the present invention on HAYNES® 282® substrates with a coating thickness of 40 microns (FIG. 2A), and 80 microns (FIG. 2B).

FIG. 3 is an optical microscope image of a cross-sectioned CoMoCrSi coating formed in accordance with certain aspects of the present invention.

FIG. 4 is a graph showing the microhardness profile of the CoMoCrSi coating of FIG. 3.

FIG. 5 shows the surface profile of an unprocessed CoMoCrSi coating.

FIGS. 6A-6D shows surface profiles of CoMoCrSi coatings remelted at 500 W (FIG. 6A), 600 W (FIG. 6B), 700 W (FIG. 6C), and 800 W (FIG. 6D).

FIG. 7 shows the surface profile of a CoMoCrSi coating remelted at 730 W.

FIGS. 8A-8C relate to microhardness measurements of remelted CoMoCrSi coatings.

FIG. 8A is a cross-section image of an 800 W-remelted coating. FIG. 8B is a cross-section image of a 730 W-remelted coating. FIG. 8C is a graph of microhardness measurement variations in the depth direction of the coatings in FIGS. 8A and 8B.

FIGS. 9A and 9B show surface hardness measurements of CoMoCrSi coatings remelted at 800 W (FIG. 9A) and 730 W (FIG. 9B).

FIG. 10 is an SEM image of a line scan of a CoMoCrSi-coated HAYNES® 282® alloy sample with no-heat treatment.

FIG. 11 shows EDS measurements of the line scan shown in FIG. 10.

FIG. 12 is an SEM image of a line scan of a CoMoCrSi-coated HAYNES® 282® sample exhibiting dilution.

FIG. 13 shows EDS measurements of the line scan shown in FIG. 12.

FIG. 14 is an SEM image of a line scan of a CoMoCrSi-coated HAYNES® 282® alloy sample showing no dilution.

FIG. 15 shows EDS measurements of the line scan shown in FIG. 14.

FIG. 16 is an SEM image of the CoMoCrSi coating of FIG. 14 near the surface thereof and an enlarged view of a portion of the coating.

FIG. 17 is an SEM image of the interface of the CoMoCrSi coating and HAYNES® 282® alloy of FIG. 14.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The following describes a hybrid approach to additive manufacturing of refractory alloy coatings on substrates having different compositions than the coatings such that the coatings are prone to cracking. As used herein, a “refractory alloy” refers to a refractory metal composition, as opposed to ceramic materials. Cracking of the refractory alloy coatings can be reduced or eliminated and properties of the refractory alloy can be preserved by reducing or eliminating diffusion between the coatings and substrates. A particular but nonlimiting example is the deposition of a cobalt-based refractory alloy (e.g., CoMoCrSi) coating on a nickel-based alloy.

The following disclosure also describes, but is not limited to, investigations in which crack-free CoMoCrSi coatings were deposited on a nickel-based superalloy commercially available from Haynes International, Inc., under the name HAYNES® 282® (sometimes referred to herein as the 282® alloy). The 282® alloy is well known as a corrosion and heat-resistant nickel-based superalloy used in applications including, but not limited to, industrial turbine applications, commercial jet engines, and rocket engines. CoMoCrSi coatings are well known for use as protective coatings (claddings) in applications where extreme wear is problematic. The CoMoCrSi coatings were formed from a cobalt-based refractory alloy obtained from Praxair S. T. Technology, Inc., under the name CO-109, which has a composition approximately the same as Tribaloy® T-400. The CoMoCrSi coatings were deposited as a molten powder by laser surface coating. To alleviate cracking of cobalt-based refractory alloy coatings deposited by laser surface coating on nickel-based alloys, previous attempts relied on preheating of the substrate to reduce cracks by alleviating a thermal mismatch between the substrate and coating alloys. In the investigations reported below, crack-free CoMoCrSi coatings were capable of being deposited on substrates formed of the 282® alloy using a hybrid process that combined a laser cladding process, in particular, laser powder bed fusion (L-PBF), and a laser remelting process that did not require preheating the substrates to prevent cracking. Process conditions of depositing crack-free CoMoCrSi coatings on the 282® alloy in accordance with certain nonlimiting embodiments of the invention were determined for both the L-PBF process and laser remelting process. Microhardness and chemical compositions of the coatings produced using these process parameters with and without remelting the substrate were compared. The chemical compositions of different phases present in the coatings were analyzed by Energy Dispersive X-ray Spectroscopy (EDS). Unlike conventional methods that include preheating the substrate, methods using a laser remelting process in accordance with the principles disclosed herein yielded minimal to no dilution at the surface, resulting in the preservation of the original and desired properties of the CoMoCrSi coatings. Research conducted in the course of developing the methods described herein showed that the laser remelting process was more amenable than existing preheating methods for scaling up to industrial applications.

As reported herein, investigations leading to the present invention utilized additive manufacturing techniques that included forming a refractory alloy coating on a substrate using an L-PBF process with a refractory alloy, and removing cracks from the refractory alloy coating by remelting the refractory alloy coating with a laser. Such a method preferably enables the refractory alloy coating to be created without cracks and without preheating the substrate or the refractory alloy, thereby minimizing or eliminating interdiffusion between the substrate and refractory alloy. The substrate may also be formed using an L-PBF process. For preferred embodiments, the step of remelting uses a scan speed that is less than the scan speed used in the L-PBF process. The laser power during the remelting step can be preferably selected to provide enough energy to fully remove cracks and also maintain an original chemical composition of the refractory alloy coating its surface. Optionally, the step of forming the refractory alloy coating may include forming the substrate as a layer of a nickel-based alloy on a base material, such as a steel substrate, and then forming a coating of the refractory alloy coating on the nickel-based alloy layer. Advantageously, the combined use of laser cladding and laser remelting can be used to achieve crack-free deposition of refractory alloys. Sequential remelting after laser deposition heals the cracks and allows building a multilayer coating on the refractory alloy layer.

In the investigations, the L-PBF process was used to deposit (clad) a Co-28.5% Mo-8.5% Cr-2.6% Si (CoMoCrSi) coating on nickel-based alloy (HAYNES® 282® alloy) substrates. The compositions of the CoMoCrSi coatings closely approximated the Tribaloy® T-400 alloy (reported to have a composition of, by weight, 28% molybdenum, 8% chromium, 2.4% silicon, 1.5% max. iron, 1.5% max. nickel, 0.08% max. carbon, balance cobalt and incidental impurities). The same L-PBF process was used to produce the 282® alloy substrates to form a seamless bi-material. The 282® alloy was chosen for the investigations as a material used in some of the hottest regions of turbines, for example, turbine rotor disks. As a coating material, although T-400 offers slightly less abrasive wear resistance than other Laves phase-rich Co-based Tribaloy® alloys, namely T-800, the balanced 50 vol % concentration of Laves phases provides higher ductility and fracture toughness. Electric Power Research Institute has reported that T-400C has performed well in oxidation and erosion at (A-USC) component operating temperature of 760° C.

In the investigations, the laser remelting technique was introduced after depositing (cladding) the CoMoCrSi coating on the 282® alloy substrates to remove coating cracks formed during the L-PBF process. The remelting approach was determined to be a more efficient method than conventional large-volume preheating methods in that it was easier to implement on large volume structures. In addition, the precise control enabled by the laser remelting process was determined to avoid metallurgical dilution between the coating and substrate materials, which is a common problem associated with laser cladding of preheated substrates.

Hereinafter, details of the investigations leading to the present invention are described.

Experimental setup: An IPG-YLS1000 ytterbium continuous-wave fiber laser with a maximum output of 1 KW power and a wavelength of 1070 nm was used to perform the experiments. The deposition process was achieved by melting and fusing pre-placed powder via a laser powder bed fusion system. The laser optics were mounted on a CNC machine to follow the laser scan path generated by a user-defined program. The laser focal plane was at the top of the powder surface with a 240 μm beam spot diameter. The process was carried out under a protective argon atmosphere to prevent oxidation during the deposition process. The building plate was low carbon steel with dimensions of 30 mm×30 mm×6.35 mm. The three-dimensional morphology of the coating surface was reconstructed by a Bruker white-light interferometer.

The substrate layers of the nickel-based 282® alloy were first produced using the L-PBF process. A gas-atomized 282® alloy powder feedstock supplied by Haynes International, Inc., was used having a particle size of −45 μm/+11 μm. The CoMoCrSi powder (Praxair CO-109; gas atomized, −45 μm/+16 μm) was subsequently cladded on the 282® alloy substrates by the L-PBF process. The reported nominal chemical compositions by weight percent of the 282® alloy and CO-109 powders are shown in Table 1.

TABLE 1

| | Co | Mo | Cr | Si | Ti | Al | C | B | Fe | Mn | Ni |
|---|---|---|---|---|---|---|---|---|---|---|---|
| CO-109 | Bal. | 28.5 | 8.5 | 2.6 | | | | | | — | |
| HAYNES ® | 10 | 8.5 | 20 | 0.15 max | 2.1 | 1.5 | 0.06 | 0.005 | 1.5 max | 0.3 max | Bal. |
| 282 ® | | | | | | | | | | | |

Process parameters were evaluated by conducting multiple experiments with varying laser power and hatch distances. The energy density E was used to characterize energy input, which measures the average applied energy per unit volume of the deposited material in the L-PBF process. The energy density E (J/mm3) is defined by Eq. (1)

$$E = \frac{P}{v \times h \times t} \qquad Eq . ( 1 )$$

where P is laser power (W), v is scan speed (mm/s), h is hatch spacing (mm), and t is the layer thickness (mm). The build rate (BR) in L-PBF is defined as the product of scan speed, hatch spacing, and layer thickness, as shown in Eq. (2).

$$BR = v \times h \times t \qquad Eq . ( 2 )$$

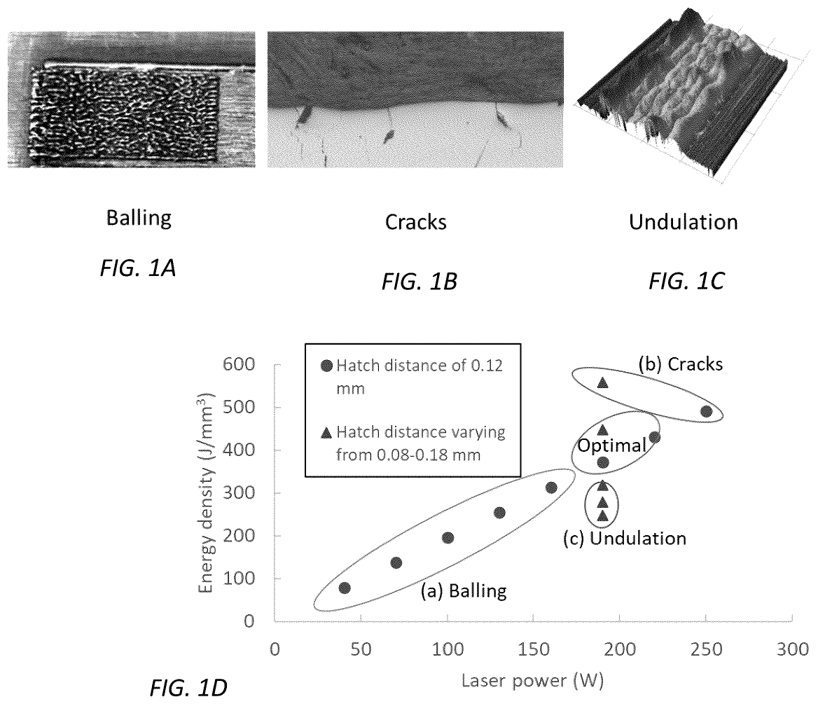

BR may be increased by increasing any associated parameters; however, the energy input is preferably sufficient to melt the powders and generate dense specimens. As shown in FIGS. 1A-1D, processing windows illustrate the process conditions used to deposit the CoMoCrSi coatings using L-PBF and a fixed scanning speed of 85 mm/s. The data points indicated in triangle markers are experiments with fixed laser power and varying hatch distances between 0.08-0.18 mm. The dot markers are experiments with varying laser power and a fixed hatch distance of 0.12 mm. The “optimal” conditions were those parameters that resulted in the coating without cracks, balling, and undulation. Within the optimal conditions, the parameters that led to the highest BR of 1.836 cm³/h were chosen, as shown in Table 2, which lists the process parameters that were used in the L-PBF process.

TABLE 2

| | Laser | | Hatch | Layer | Build | Energy | Power | |
|---|---|---|---|---|---|---|---|---|
| | power | Speed | spacing | thickness | rate | density | density | Inert |
| Powder | (W) | (mm/s) | (mm) | (mm) | (cm³/h) | (J/mm³) | (kW/cm2) | gas |
| 282 ® | 170 | 85 | 0.12 | 0.05 | 1.836 | 333.3 | 375.8 | Argon |
| Alloy | | | | | | | | |
| CO-109 | 190 | 85 | 0.12 | 0.05 | 1.836 | 372.5 | 419.9 | Argon |

The CoMoCrSi (CO-109) coating deposited by the L-PBF process was subsequently post-processed by remelting. The purpose of the remelting process was to remove any surface cracks formed during the L-PBF process. Post-process parameters shown in Table 3 were optimized to remove all pre-existing cracks whilst preventing dilution between the primary structure (the 282® alloy substrates) and CoMoCrSi (CO-109) coatings. The optimized post-process parameters used for the remelting process were: power (P)=730 W, scanning speed (v)=42.5 mm/s, hatch spacing (h)=0.12 mm. Table 3 below lists the process parameters that were used in the optimization of the remelting process.

TABLE 3

| Remelting | | | | | Average |
|---|---|---|---|---|---|
| process | Laser | | | | hardness |
| experiment | power | Speed | | | at the |
| number | (W) | (mm/s) | Cracks | Dilution | surface (HV) |
| 1 | 500 | 42.5 | ◯ | X | N/A |
| 2 | 600 | 42.5 | ◯ | X | N/A |
| 3 | 700 | 42.5 | ◯ | X | N/A |
| 4 | 730 | 42.5 | X | X | 855.7 |
| 5 | 800 | 42.5 | X | ◯ | 477.4 |

Next, the methods and results of the investigations are discussed.

Characterization of cracking in the coating: The 282® alloy powder was first deposited onto a low carbon steel build plate using the L-PBF process with the parameters shown in Table 3. The 282® alloy deposition process did not require preheating the build plate or a remelting procedure to achieve a crack-free structure. The same L-PBF process was used to clad the CoMoCrSi coatings onto the primary 282® alloy substrate. The coating thickness/number of the coatings was sufficient to avoid dilution between the 282® alloy substrate and CoMoCrSi coating at the surface. In the first application of the CoMoCrSi coating, nickel penetrates through the coating/substrate interface as it is the main element in the 282® alloy substrate. The dilution of the CoMoCrSi coating will reduce the formation of the hard Laves phase. Therefore, the number of CoMoCrSi layers required to complete the coatings was chosen to be sufficient to attain the pure CoMoCrSi alloy at the surface of the coatings. The following process parameters were fixed for finding the optimum coating thickness: laser power, inert gas type, powder thickness, and scanning speed.

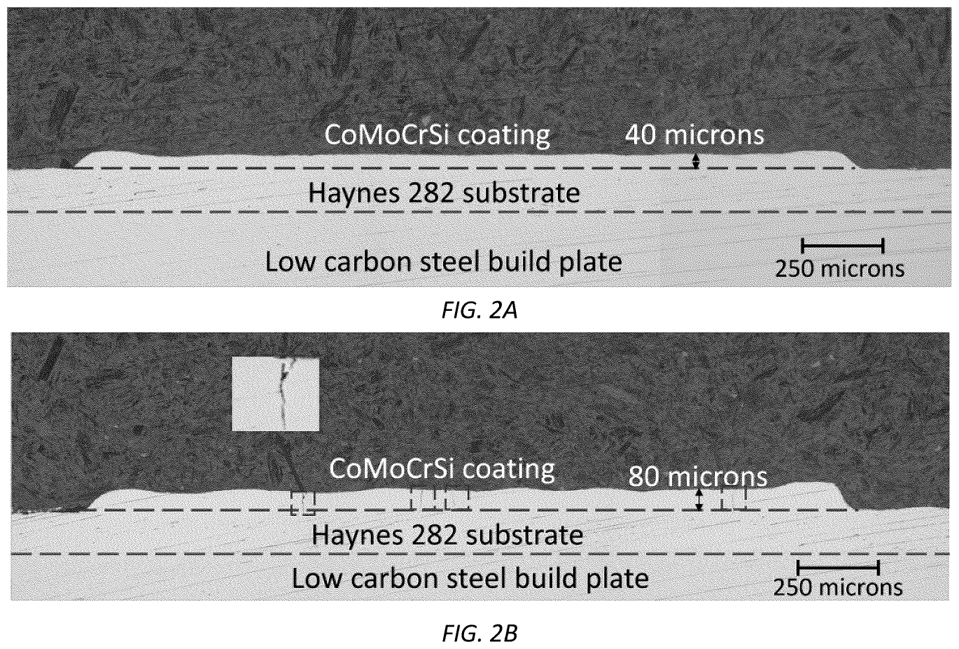

FIGS. 2A and 2B show the cross-sections of the 282® alloy substrate coated with the CoMoCrSi layer produced under process parameters with a coating thickness of 40 and 80 microns, respectively. As shown in FIG. 2A, with a single layer 40-micron coating, the cross-section shows no visible cracks and defects in the sample. However, the single-layer deposition process diluted the single CoMoCrSi layer as the laser partially remelts the previously deposited 282® alloy layer. The dilution of the nickel from the 282® alloy substrate to the CoMoCrSi layer promotes and stabilizes the FCC matrix crystal structure. Therefore, the dilution of the nickel aided in preventing cracking during L-PBF of the CoMoCrSi layer. However, dilution should still be minimized as molybdenum content, which contributes to the formation of Laves phases (CoMoSi), is reduced. As shown in FIG. 2B, multiple cracks appeared in an 80-micron coating formed by two CoMoCrSi layers. The microhardness was measured near the surface of the 80-micron coating. The microhardness near the surface was 485 HV, similar to an as-cast T-400 but falling short of the 1000-1200 HV values reported in the literature. This lower-than-expected microhardness measurement at the coating surface necessitated a thicker coating.

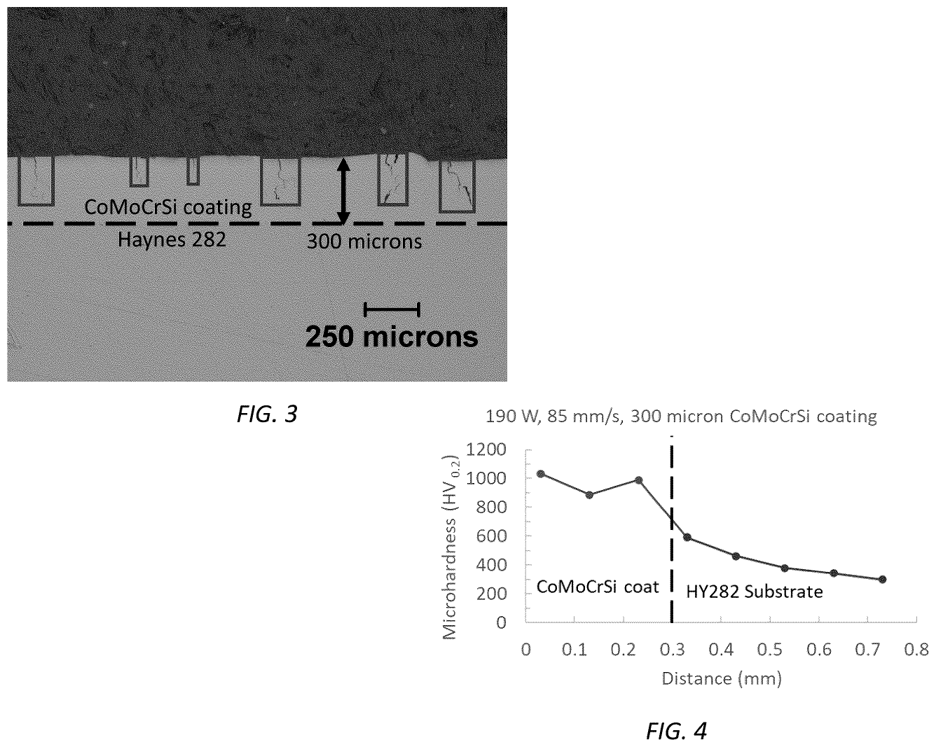

The CoMoCrSi coating thickness was extended to 300 microns by applying additional layers using the L-PBF process. The cross-section image of a 300-micron coating, as shown in FIG. 3, reveals an increased frequency in crack formation. FIG. 4 shows the microhardness profiles obtained across the depth of the 282® alloy substrate with a 300-micron coating. A 1030 HV microhardness value measured at the surface was consistent with the literature-reported values for Tribaloy® T-400. The microhardness value measured at the interface level (0.3 mm) dropped significantly to 590 HV due to the large mixing between the 282® alloy and the CoMoCrSi alloy. Microstructure changes were expected at the interface due to significant dilution. Based on the hardness measurements, a coating thickness of at least 300 microns was concluded to be necessary to provide sufficient hardness for applications in critical equipment. A detailed account of dilution measurements is detailed hereinafter using scanning electron microscopy (SEM)/Energy-dispersive X-ray Spectroscopy (EDS) Analysis.

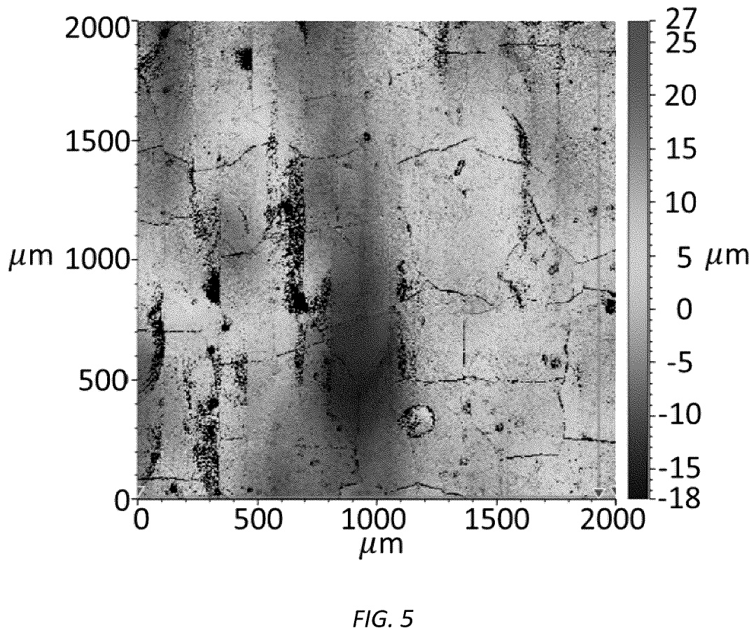

A CoMoCrSi coated 282® alloy sample was built to a dimension of 18×12×1.5 mm. The 282® alloy and CoMoCrSi powders were deposited up to 1.2 mm and 0.3 mm thickness, respectively. As shown in FIG. 5, the optical surface profiler was used to detect surface cracks in the unprocessed (non-remelted) sample. As expected, multiple cracks appeared throughout the CoMoCrSi coating using the process parameters shown in Table 3. Cracks are visible in FIG. 5 as black lines formed between numerous zones. The formation of multiple cracks indicated that the thermal expansion mismatch between the substrate and coating material induced significant residual stresses. One of the common strategies used to reduce this thermal gradient in known conventional methods is to preheat the substrate. However, preheating of the substrate can cause a significant reduction of hardness by increased dilution of the coating by the substrate material.

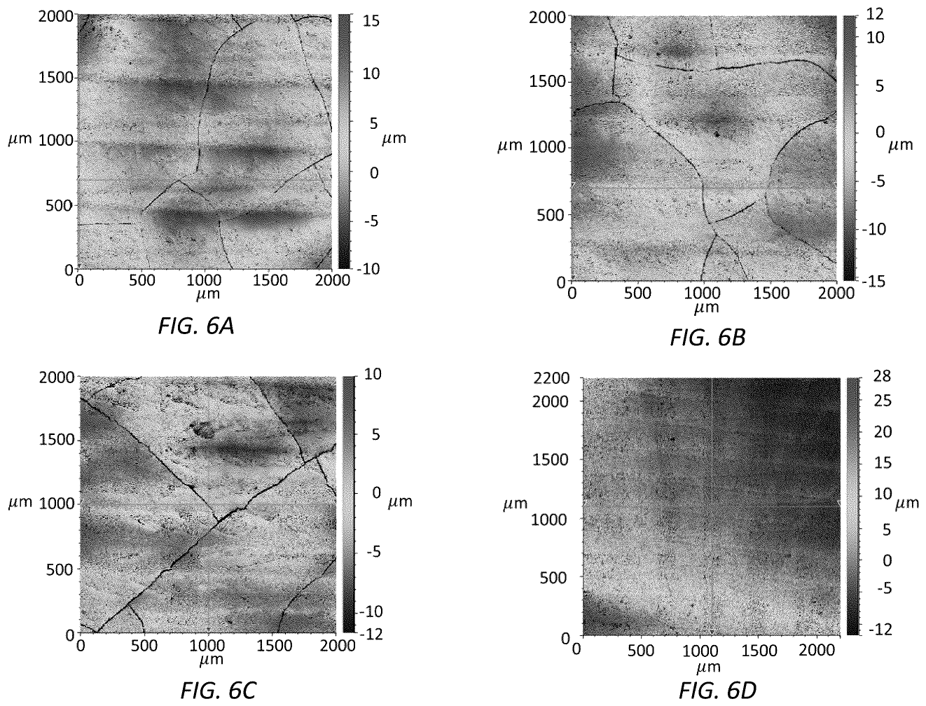

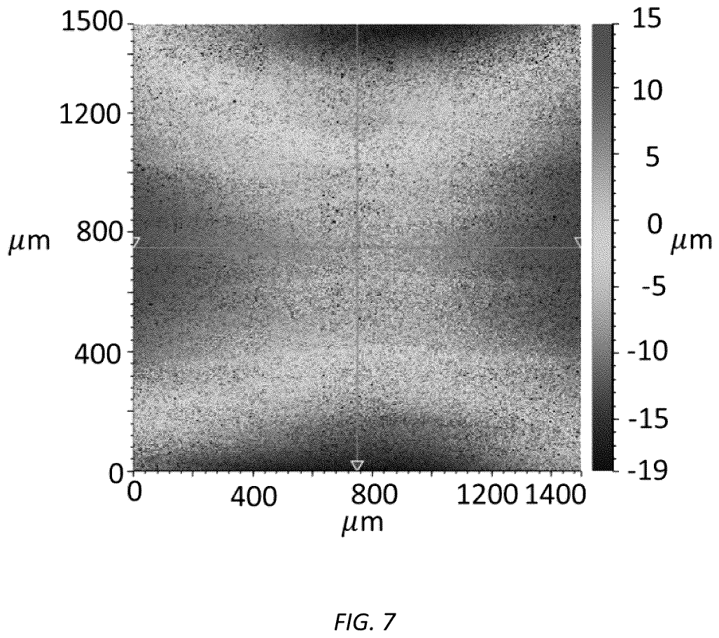

The laser remelting process employed in the investigations differed from the conventional approach as the cracks are repaired following the deposition process without requiring the preheating of the substrate material. The remelting process used a lower scan speed (v=42.5 mm/s) than that used in the L-PBF process to lessen the resultant thermal gradient and residual stress. The laser power was adjusted to provide enough energy to fully remove cracks (by remelting) while still maintaining the original chemical composition of the CoMoCrSi alloy at the coating surface. In order to determine effective laser power conditions for the remelting process, different power levels ranging from 500 W to 800 W were selected. Surface profiles of the remelted coatings are shown in FIGS. 6A-6D. The remelting by lower power levels between 500 W to 700 W, as shown in FIGS. 6A-6C, significantly reduced the cracks, but complete removal was not achieved. As shown in FIG. 6D, a laser power of 800 W provided sufficient energy to remove all pre-existing cracks. One concern of using the remelting process is diluting the CoMoCrSi alloy coating by mixing the molten materials of 282® alloy and CoMoCrSi alloy. Therefore, the laser power for the remelting process was reduced further from 800 W to the point where the cracks were still completely removed. As shown in FIG. 7, the cracks were removed entirely from the surface with the remelting process with the laser power at 730 W.

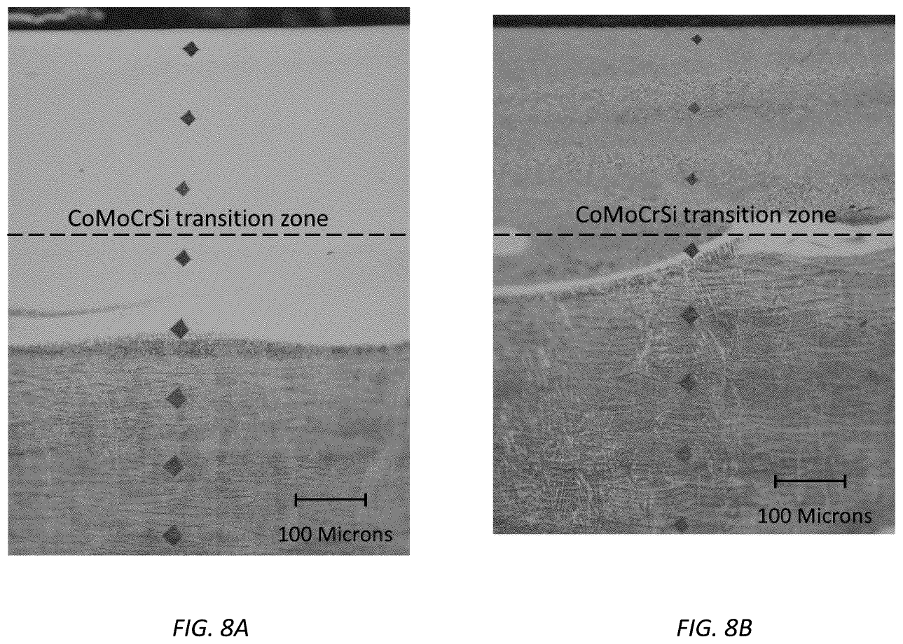

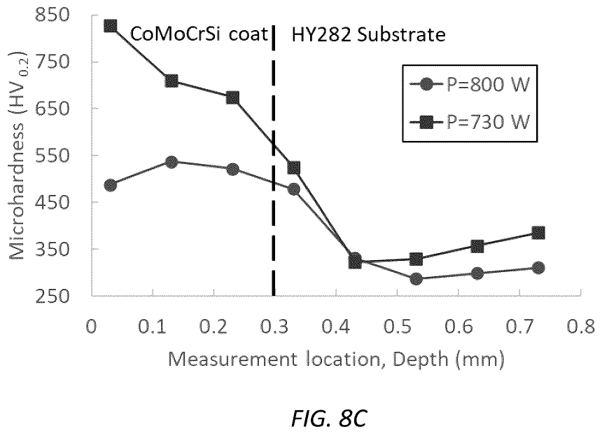

Next, the effect of the laser remelting process used in these investigations on surface hardness was examined. The microhardness of the CoMoCrSi coating was measured in the depth direction for the remelting cases of 730 W and 800 W. The CoMoCrSi coating was etched using Kalling's reagent number 2 to reveal the microstructure. As shown in the cross-section image in FIG. 8A, the CoMoCrSi layer did not react to the etchant, most likely from the significant dilution caused by the remelting process. FIG. 8C shows that the 800 W remelting condition showed a reduced near-surface microhardness value of 450.6 HV. The lower than expected microhardness value indicated that the increased power of 800 W was too high, resulting in the mixing of the primary substrate and the coating. In contrast, the 730 W remelting case showed a much higher near-surface microhardness value of 826.6 HV. Kalling's reagent number 2 clearly resolved the macrostructure of the CoMoCrSi coating for the 730 W remelting case, as shown in FIG. 8B.

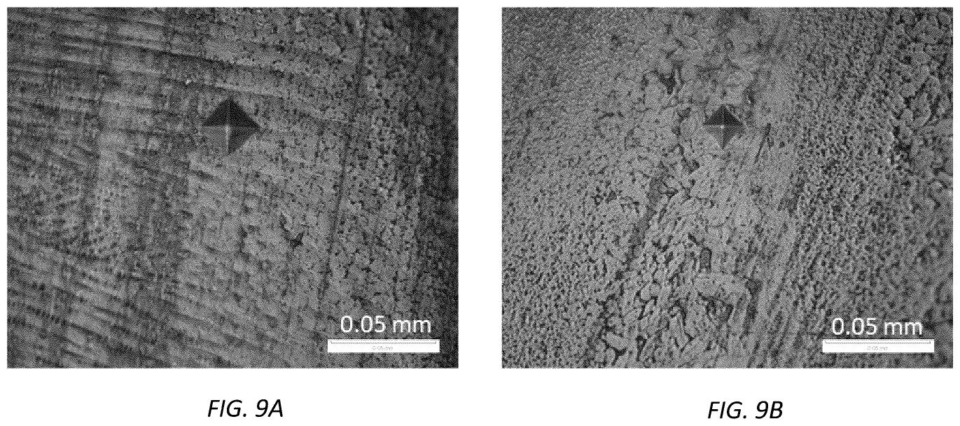

The microhardness was also measured directly on the surface of the remelted CoMoCrSi coatings. The average hardness measurement at the surface was 477.4 HV for the 800 W remelted sample, while it was 855.7 HV (min of 782.9 HV and max of 911.5 HV) for the 730 W case. The significant difference in the indent size from the microhardness measurements is apparent, as shown in FIG. 9.

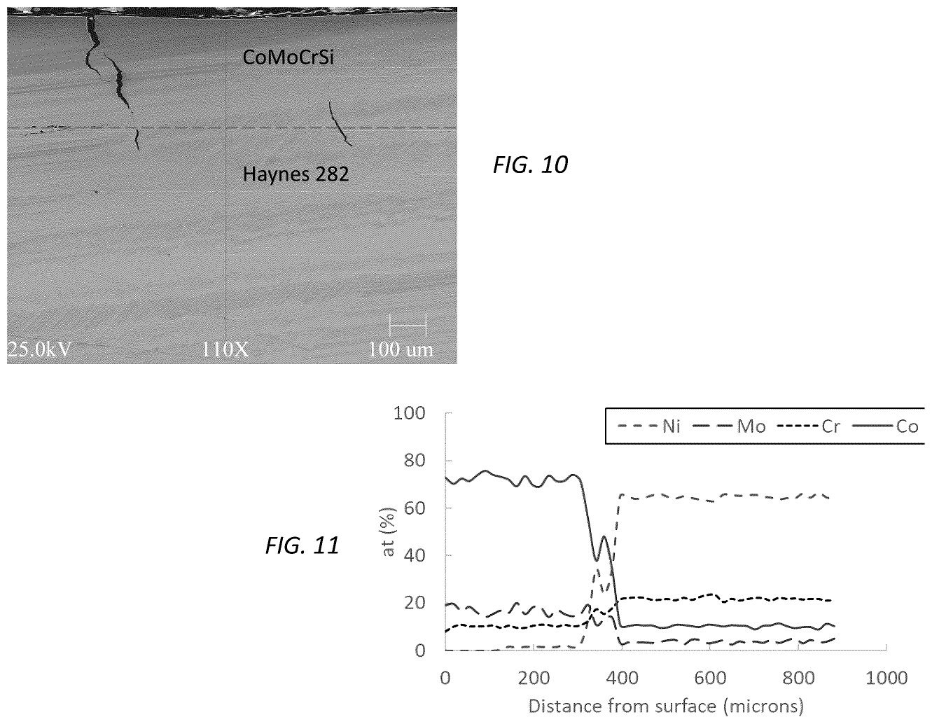

Next, the effect of the laser remelting process used in these investigations on dilution was examined. FIG. 10 shows the SEM image of an unprocessed (non-remelted) CoMoCrSi coating. The SEM image shows that the non-heat treated sample contains multiple cracks emerging from the transition boundary between the 282® and CoMoCrSi alloys. The linear EDS analyses were performed in the vertical direction, and the average chemical compositions were obtained. The line scanning length was 850 microns starting from the surface, as shown by the vertical line. FIG. 11 shows the EDS measurements corresponding to the vertical line of FIG. 10. As shown in FIG. 11, the CoMoCrSi and 282® alloy transition took place at the 300-micron mark. This transition zone was identifiable as the CoMoCrSi powder does not contain Ni content. The interface exhibited an ideal continuous compositional change. From this it can be seen that, without the remelting process, the original CoMoCrSi powder chemical composition was maintained throughout the 300-micron coating.

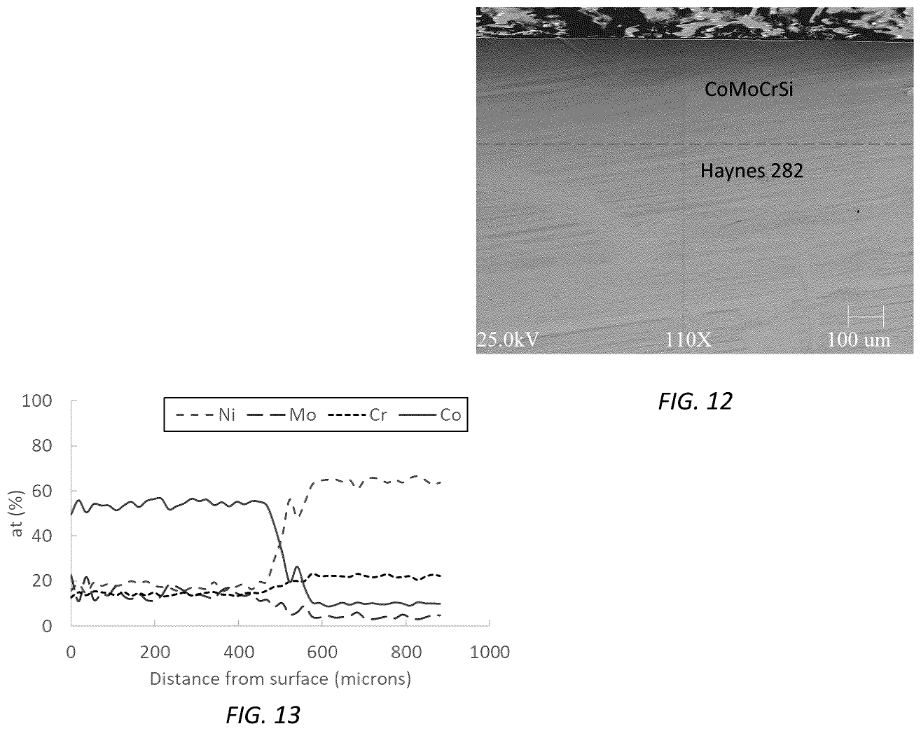

FIG. 12 shows the SEM image of a remelted sample made in accordance with the present method with a laser power of 800 W. The sample contained no cracks throughout the entire CoMoCrSi coating. However, there was significant dilution between CoMoCrSi and 282® alloys as indicated by the high nickel content measured at the surface, as shown in FIG. 13. The transition between CoMoCrSi and 282® alloys occurred at a considerable length of 200 microns. The dilution by the 282® alloy resulted in the CoMoCrSi coating having a chemical composition (16.6Mo-14.0Cr-17.0Ni-bal.Co) similar to Tribaloy® T-900 (23Mo-18Cr-16Ni-3Si-bal.Co). Tribaloy® T-900 contains Laves phase but exhibits higher ductility and crack resistance than other Co-based Tribaloy® alloys. The volume fraction of the Laves phase in the alloy was essentially reduced by increasing the nickel content and reducing the cobalt content.

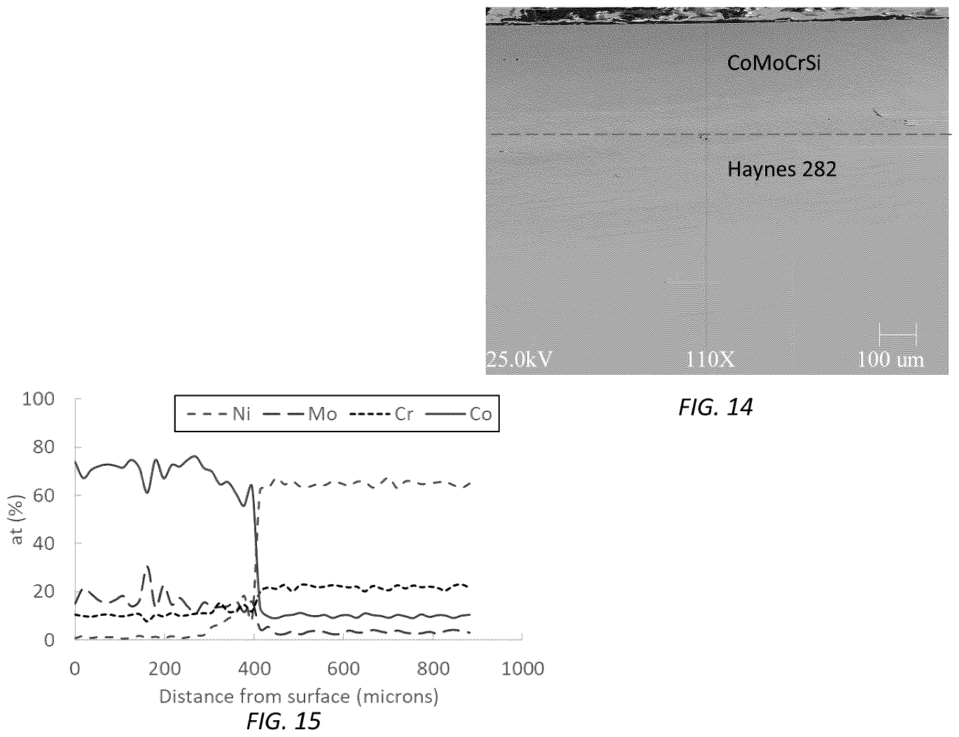

FIG. 14 shows the SEM image of a remelted sample made in accordance with the present method with a laser power of 730 W. As shown in FIG. 15, the EDS measurements were very similar to the non-heat treated sample, indicating low to no dilution. In addition, no significant nickel content was measured near the surface. The dominant elements were Co, Mo, and Cr, which corresponded well to the original composition of the initial CoMoCrSi powder. Therefore, the difference in hardness between the non-remelted and the remelted samples by 730 W was not attributed to the dilution effect. Instead, the cooling rate difference between the L-PBF process and the remelting process was believed to be the reason for the hardness values. More specifically, the cooling rate of the remelting process was lower due to slower scanning speeds.

Table 4 shows the chemical compositions of the spot scan measurements at the surface and the bottom (850 microns from the surface), and in particular, a chemical composition comparison between EDS measurements and reported values by powder supplier.

TABLE 4

| Material/EDS | Ni | Cr | Co | Mo |
|---|---|---|---|---|
| measurement | (at %) | (at %) | (at %) | (at %) |
| EDS measurement at the | 0 | 8.0 | 72.9 | 19.1 |
| surface (non-remelted) | | | | |
| EDS measurement at the | 15.6 | 12.5 | 49.4 | 22.4 |
| surface (P = 800 W) | | | | |
| EDS measurement at the | 1.5 | 10.5 | 67.1 | 21.3 |
| surface (P = 730 W) | | | | |
| EDS measurement at the | 63.8 | 21.2 | 10 | 4.9 |
| bottom, 850 microns | | | | |
| (non-remelted) | | | | |
| EDS measurement at the | 63.6 | 22.1 | 9.7 | 4.6 |
| bottom, 850 microns | | | | |
| (P = 800 W) | | | | |
| EDS measurement at the | 65.0 | 21.6 | 10.3 | 3.0 |
| bottom, 850 microns | | | | |
| (P = 730 W) | | | | |

The EDS measurements at the surface for the non-remelted sample showed no nickel content. The molybdenum content measured at the surface was lower than the reported values from the powder manufacturer. A few reasons may have caused this, such as the element segregation occurring during the L-PBF process. The fluctuation of molybdenum content was evident, as shown in FIG. 15, which could give uncertainties in the spot measurement. In addition, the EDS measurement very close to the interface may not be accurate due to the possible errors in beam positioning. The 730 W laser power showed a very low 1.5 at % of Ni content at the surface, indicating low to no dilution.

On the other hand, the 800 W remelted sample showed a significant nickel content of 15.6%. The measurements at the bottom all showed similar chemical compositions to the original 282® alloy power composition. This indicated that the dilution did not occur at the 850-micron depth.

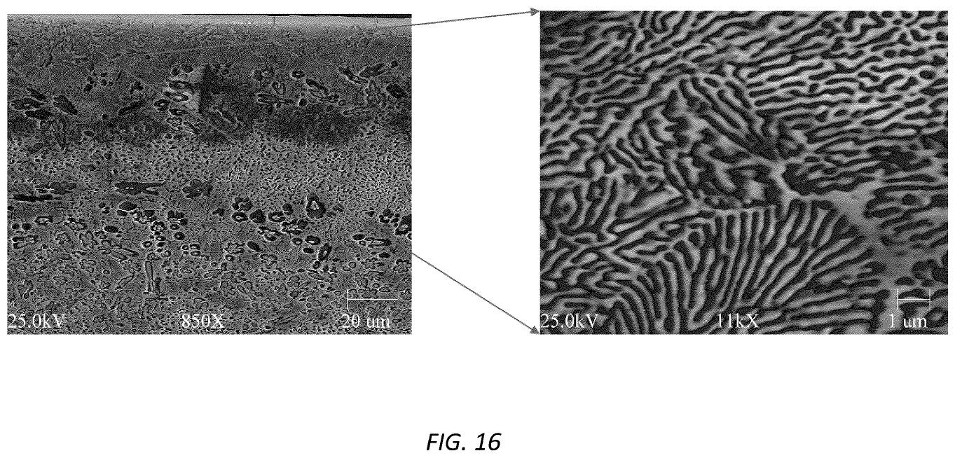

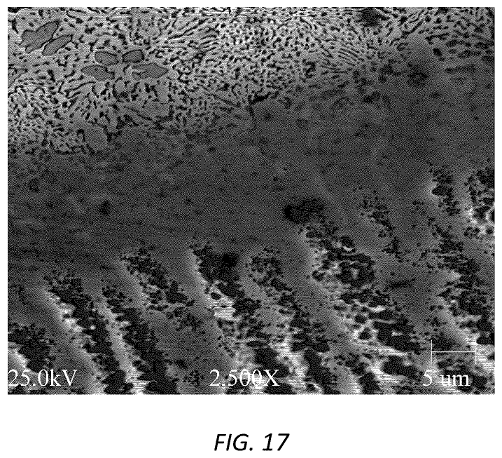

Next, the effect of the laser remelting process used in the investigations on microstructure was examined. The microstructure of the 730 W remelted sample was investigated by SEM. As shown in FIG. 16, the microstructure showed a metallurgically sound structure without cracks. The white primary phase was concluded to be a CoₖMoₗSiₘ (wherein k, l, and m are atomic fractions)-type of intermetallic Laves phase. The dark eutectic phases were concluded to be a mixture of Co-rich solid solutions. FIG. 17 shows the microstructure of the interface between the coating (CoMoCrSi) and substrate (282® alloy). Strong bonding between the substrate and coating is expected as continuous phase change occurs at the interface from the eutectic phase to white particles segregated predominantly in the interdendritic region.

A significant advantage of the laser remelting technique disclosed herein is the possibility of depositing crack-free coatings without preheating the substrate. This laser remelting technique significantly reduces the complexity by eliminating another heating element that can easily cause dilution of the coating. In addition, preheating a substrate may be difficult and expensive for large complex structures. In contrast, the laser remelting process disclosed herein can be applied to large structures because the process can be applied selectively in a desired region. A larger thickness in the coating of refractory alloy coating can also be used by introducing intermediate steps of the remelting process during the L-PBF process. The laser remelting process can achieve a high-volume percentage of the hard Laves phase compared to the preheating method.

In view of the investigations discussed herein, it is believed that one or more of the following conclusions can be drawn regarding these particular tests. The L-PBF process with sequential laser remelting was utilized to clad a crack-free CoMoCrSi coating on 282® alloy with a maximum hardness of 911.5 HV. The optimum conditions of L-PBF of a CoMoCrSi coating on a 282® alloy substrate without cracking were experimentally determined to be a laser power of 190 W, scanning speed of 85 mm/s, energy density of 372.5 J/mm3, and layer thickness of 50 microns. The remelting process preferably is controlled to prevent dilution between the 282® alloy and CoMoCrSi coating. A laser power of 730 W exhibited the best performance for the remelting/crack-removal process. Nickel dilution in the coating from the substrate caused a hardness reduction due to an increase in the FCC phase with an attendant decrease in the hard Laves phase. The remelting process with a higher laser power of 800 W led to an increase in nickel content in the CoMoCrSi coating that more closely resembled Tribaloy® T-900 than T-400. This resulted in a significant reduction in hardness of 477.4 HV. Based on the SEM/EDS analyses performed, it can be seen that in some configurations the laser remelting process disclosed herein successfully minimized dilution in the coating compared to the preheating method. However, these specific observations of these investigations are not intended as limitations on the present invention, but are provided only as examples of one specific nonlimiting embodiment.

In some embodiments, the methods of the present disclosure are preferably capable of improving over previously known methods because it can preserve the original and desired properties of the coated refractory alloy and eliminates cracks. In addition, refractory alloy coatings formed using the methods of the present disclosure may be applied to selective regions. For refractory alloy coatings formed using the methods of the present disclosure, preheating parts with large sizes or complex surfaces may not be necessary to avoid cracks. Thus, the methods may allow for forming areas to have a refractory alloy surface without any preheating and still avoid the formation of cracks in the refractory alloy and/or surrounding material(s).

As previously noted above, though the foregoing detailed description describes certain aspects of one or more particular embodiments of the invention, alternatives could be adopted by one skilled in the art. For example, the methods and their components could differ in appearance and construction from the embodiments described herein and shown in the drawings, functions of certain components of the methods could be performed by components of different construction but capable of a similar (though not necessarily equivalent) function, and various materials could be used in implementation of the methods. As such, and again as was previously noted, it should be understood that the invention is not necessarily limited to any particular embodiment described herein or illustrated in the drawings.

1. A method of additive manufacturing of refractory alloy coating, the method comprising:
forming a refractory alloy coating on a substrate using a laser powder bed fusion (L-PBF) process with a refractory alloy; and
removing cracks from the refractory alloy coating by remelting the refractory alloy coating with a laser.

2. The method of claim 1, wherein the refractory alloy coating is created without preheating the substrate or the refractory alloy.

3. The method of claim 1, wherein the refractory alloy is a cobalt-based refractory alloy.

4. The method of claim 3, wherein the refractory alloy is a CoMoCrSi refractory alloy.

5. The method of claim 4, wherein the CoMoCrSi refractory alloy coating consists essentially of 28.5% Mo-8.5%-Cr-2.6% Si, the balance cobalt and incidental impurities.

6. The method of claim 5, wherein the substrate comprises a corrosion and heat-resistant nickel-based alloy.

7. The method of claim 1, wherein the substrate is a nickel-based alloy having a nominal composition in weight percent of about 20% chromium, 10% cobalt, 8.5% molybdenum, 2.1% titanium, 1.5% aluminum, 1.5% maximum iron, 0.3% maximum manganese, 0.15% maximum silicon, 0.06% carbon, 0.005% boron, the balance nickel and incidental impurities.

8. The method of claim 1, wherein the step of forming the refractory alloy coating comprises:
forming the substrate of a layer of a nickel-based alloy on a base material; and
forming a layer of the refractory alloy on the layer of the nickel-based alloy.

9. The method of claim 8, wherein each of the steps of forming the substrate of the nickel-based alloy and forming the layer of the refractory alloy coating is accomplished by an L-PBF process.

10. The method of claim 1, wherein the step of remelting uses a second laser scan speed that is less than a first laser scan speed used in the L-PBF process.

11. The method of claim 1, wherein the laser during the remelting step has a laser power that provides sufficient energy to fully remove cracks by remelting the refractory alloy coating and also maintain an original chemical composition of the refractory alloy coating at a surface of the refractory alloy coating.

12. The method of claim 11, wherein the laser during the remelting step has a laser power between about 700 W and 800 W and a scanning speed of between about 42 m/s and 43 m/s.

13. The method of claim 12, wherein the laser power is about 730 W.

14. The method of claim 12, wherein the scanning speed is about 42.5 m/s.

15. The method of claim 1, wherein the refractory alloy coating has a thickness of at least 300 microns.
